(19) United States
(12) Patent Application Publication
(10) Pub. No.: US 2004/0005078 A1
(43) Pub. Date: Jan. 8, 2004

(54) Method and apparatus for digitally watermarking images created with a mobile imaging device

(75) Inventor: Scott Andrew Tillotson, North Kingstown, RI (US)

Correspondence Address: HARRINGTON & SMITH, LLP, 4 RESEARCH DRIVE, SHELTON, CT, 06484-6212, US

(73) Assignee: Spectra Systems Corporation

(21) Appl. No.: 10/600,168

(22) Filed: Jun. 19, 2003

Related U.S. Application Data
(60) Provisional application No. 60/390,698, filed on Jun. 21, 2002.

(51) Int. Cl. G06K 9/00

(52) U.S. Cl. 382/100

(57) ABSTRACT

A digital watermarking system in accordance with these teachings includes a mobile device having a image capture sub-system for generating digital data representative of an image. Information related to the image at the time of imaging is used as input information for the digital watermarking software. The related information may be stored separately from the image, and subsequently included in the image by remote processing. Appropriate components are included in the device for imaging, processing and communicating with other apparatus. Digitally watermarked images can be stored in the mobile device, or transferred through the wireless link to a data communications network, such as the Internet. These teachings also pertain to methods for using the mobile device and related systems.

### CROSS REFERENCE TO RELATED APPLICATION

This patent application claims priority under 35 U.S.C. §119(e) to co-pending U.S. Provisional Patent Application No. 60/390,698 filed Jun. 21, 2002, and entitled “Method and Apparatus for Digitally Watermarking Images Created with a Hand-Held Image Device,” the disclosure of which is incorporated by reference herein in its' entirety.

### FIELD OF THE INVENTION

These teachings relate to a portable apparatus and methods for digitally watermarking images.

### BACKGROUND OF THE INVENTION

Many images or photographs, such as those taken by law enforcement or other official agencies, are considered valuable, and are therefore attractive for fraudulent alteration. Advancements in various printing and digital photography technologies, for example, color laser printers, PC image processing software and color scanners, have improved the ability to counterfeit or alter many types of digital media. As a result, authentication or security schemes have likewise advanced in order to preserve the value of original images and digital media.

An example of an advanced security scheme for protecting digital images is a digital watermark. Digital watermarks are increasingly used in a variety of applications. Digital watermarks are typically produced by using information related to the item to be protected. For example, digital watermarks may include information obtained from alphanumeric characters, physical features, etc. or other related information (e.g. ownership information). These signatures, or watermarks, are typically kept with or incorporated, covertly or overtly, into the image to be protected. For example, a watermarked image may be printed on the substrate of a identity document that includes information regarding the subject and the originator of the instrument.

Some of the known techniques include separately coding the image and a watermark image using a pseudo random number generator and a discrete cosine transform (DCT) to form coded blocks, one of the image to be watermarked and the other of the watermark itself. The DCT coefficients representing the coded watermark block and the coded image block are then added together to form a combined block thus digitally watermarking the image.

Various digital watermarking techniques are known for both still and video images. For example, reference may be had to U.S. Pat. No. 6,343,138 B1, entitled “Security Documents with Hidden Digital Data”, issued Jan. 29, 2002. This patent discloses, among other things, embedding a digital watermark into a video signal or a still image.

Reference may also be had to U.S. Pat. No. 6,037,984, entitled “Method and Apparatus for Embedding a Watermark into a Digital Image or Image Sequence,” by Isnardi et al., issued Mar. 14, 2000. This patent discloses watermarking an image or sequence of images using a DCT unit and quantizer. The patent discloses generating an array of quantized DCT coefficients and watermarking the array by selecting certain ones of the DCT coefficients and replacing them with zero values. The masked array is further processed by a watermark inserter that replaces the zero valued coefficients with predefined watermark coefficients to form a watermarked array of DCT coefficients, that is, a watermarked image.

As can be expected, the incorporation of digital watermark information into an image requires more capability than typically provided with a conventional digital camera alone. For example, a processor is required to process an image in accordance with U.S. Pat. No. 6,037,984, cited above. Additionally, other sophisticated equipment may be required to effectively code such complicated security schemes.

An example of authentication techniques is published in U.S. Pat. No. 6,243,480 B1, entitled “Digital Authentication with Analog Documents,” issued Jun. 5, 2001. This patent discloses techniques for protecting the security of digital representations of data, and of analog forms made from them.

Reference may also be had to U.S. Pat. No. 6,535,618, entitled “Image Capture Device with Steganographic Data Embedding” issued Mar. 18, 2003 to Rhoads. This patent discloses an image capture device, disclosed as a scanner that is provided with processing circuitry to steganographically embed plural-bit auxiliary data within image data.

There is an increasing need for secure versions of information and image data that may be created at the exact source of recording or capture in remote locations, or in mobile situations. For example, there is a growing need for officials in the law enforcement community to obtain and protect authentic images or authenticate images of certain individuals. Preferably, systems that address this need will include additional information that may be used to provide further perspective on the content of the image presented. The need for authentic images, the demands of creating digital watermarked images, and the need for user flexibility, calls for a robust system for digital watermarking of images.

### SUMMARY OF THE INVENTION

These teachings are directed to a field based apparatus for obtaining digital images and creating digitally watermarked versions of the digital images. The apparatus is a versatile instrument that is capable of mobile or field based use. The teachings herein also pertain to methods for using the device as a portable, hand-held device with related systems. However, one skilled in the art will recognize that while the teachings herein are illustrative of a hand-held apparatus for creating a digitally watermarked image, the teachings are not limiting of the use, the features, or other aspects of the apparatus.

Aspects of the apparatus may include, but are not limited to, at least some of: a charge coupled device (CCD) light sensor pixel array coupled to a lens; an illumination source or sources; a processor; a user display; a memory, which is permanent and/or removable; non-volatile storage; user interface features such as a keyboard and/or touch screen display; communication links that may include IR and/or RF links, a wireless transceiver, serial and/or parallel ports; a location determination system (LDS), such as a global positioning system (GPS) receiver and a power supply.

Image data may be collected by the light sensor pixel array, or received from an external source via one of the communication links. The image data is sent to the processor for coding with a digital watermark, using an appropriate algorithm. The algorithm used may be an algorithm that is programmed by the user, selected from available algorithms, or downloaded via a communication link, such as through the transceiver. Digital watermarking software incorporates appropriate information, in a form called for by the algorithm, and creates a digitally watermarked image. Digitally watermarked images may be uploaded to other systems through various means including removable memory cards, or one of the communication links.

The apparatus may make use of varied sources of information for creating a digital watermark. Preferably, the information used is evanescent information that is deemed relevant to the image. In one embodiment, the apparatus makes use of location specific information provided by the location determination system. The information may be incorporated into the digital watermark through various methods, including use of a one way hash, or some other function for generating the digital watermark. As another example, the apparatus may be connected to external sensors providing biometric data. For instance, the apparatus may be connected to a hand or fingerprint scanner, where information from the hand or fingerprint scanner may be incorporated as a digital watermark into an image of a person's face, and later recorded on an identification document.

### BRIEF DESCRIPTION OF THE DRAWINGS

The above set forth and other features of the invention are made more apparent in the ensuing Detailed Description of the Invention when read in conjunction with the attached Drawings, wherein:

FIG. 1 is a block diagram showing the major sub-components of a hand-held, portable, apparatus for incorporating digital watermarks into images;

FIG. 2 is an elevational view of the apparatus of FIG. 1;

FIG. 3 is a simplified block diagram of the hand-held, portable apparatus having a wireless link to a remote data processor, such as one that may be used by Law Enforcement Officials to record (and watermark) images of a crime scene;

FIG. 4 is a depiction of a method to collect an image using location specific input information;

FIG. 5 shows the apparatus used in conjunction with an inclinometer;

FIG. 6 is a flow chart depicting the flow of data associated with the use of the apparatus; and,

FIG. 7 is a block diagram depicting a further embodiment of the apparatus disclosed herein.

### DETAILED DESCRIPTION OF THE INVENTION

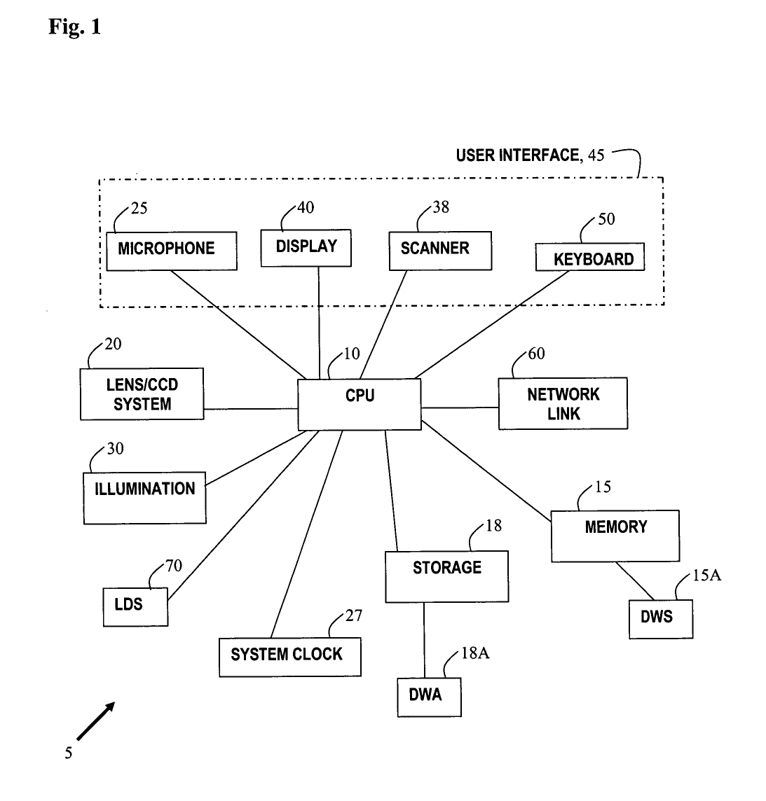

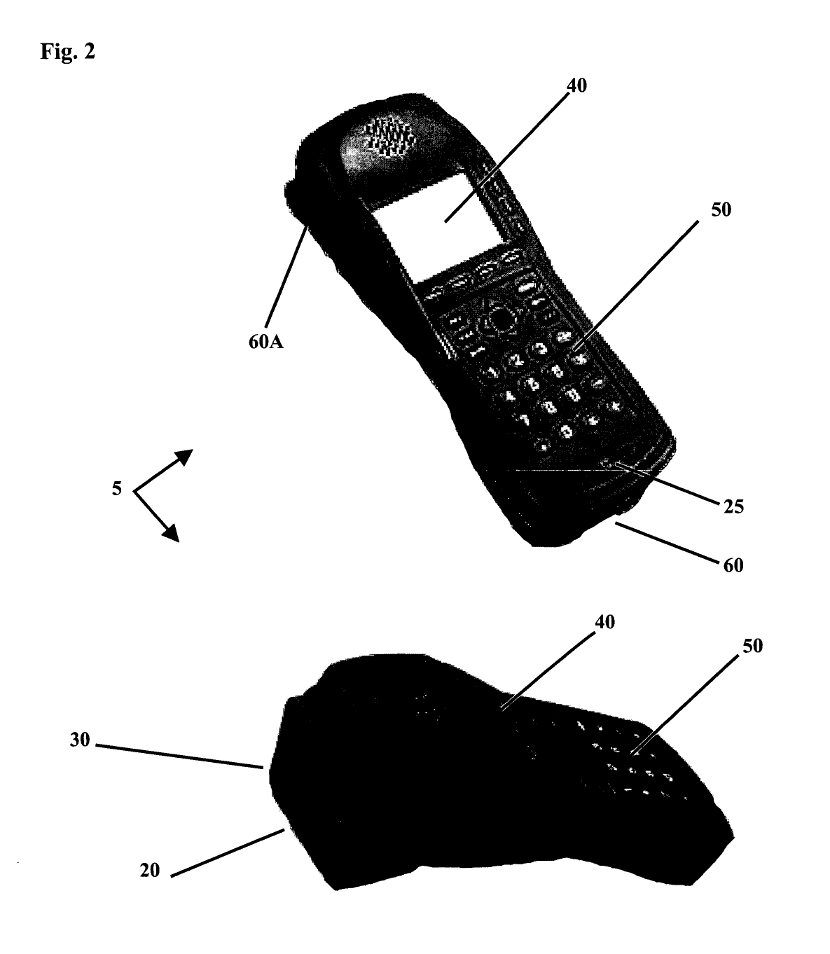

Referring to FIGS. 1 and 2, a hand-held apparatus for digital watermarking, or device 5 includes a CPU 10, such as an embedded microprocessor, an internal read/write memory 15 and optional, preferably non-volatile mass storage 18. Also included is a digital camera lens/CCD system 20, at least one illumination source 30 and a user interface 45 that includes a display (LCD) 40 and a keypad or keyboard 50. The illumination source 30 can be a variable intensity source controlled by an operator, and it can also include a flash source. However, in some embodiments the illumination source 30 may not be necessary, depending on the ambient illumination conditions. The device 5 may include additional input devices, such as a scanner 38 for collection of biometric data such as fingerprint or retina data. The device 5 (or “apparatus”), may include some or all of the components shown in FIG. 1. Other components not shown may be included as appropriate.

Although described herein as a “hand-held” device 5, the device 5 is not to be limited by this description. That is, the device 5, may be other than hand-held, and is generally considered “mobile” or “field based,” meaning that the device 5 may be used in applications that do not afford or provide the controls or resources of a laboratory setting. The terms “mobile” or “field based” may also be taken to mean that the device 5 is ported to a location where it shall be used on a temporary or short term basis. This will become more apparent in light of examples of mobile operation provided herein. Therefore, although the device 5 is referred to as being preferably “hand-held” it may be otherwise positionable or operable. For example, the device 5 may be vehicle based, and/or tripod mounted. The device 5 may be an integrated unit, or a collection of separate components. The separate components may be separately serviced, or require some degree of assembly prior to operation. Preferably, and as discussed herein, the device 5 is an integrated hand-held unit, although this embodiment, and the features thereof, are not limiting of the invention disclosed herein.

The lens/CCD system 20 and illumination source 30 can be located on a surface opposite that of the display 40 and keyboard 50. The operator may view the image being captured on the display 40, manipulate the keys of the keyboard 50, initiate the operation of the digital watermarking software (DWS) 15A stored in the memory 15 or 18, and perform other functions. One example of other functions includes initiating a transfer of data to a remote location via a wireless network link 60 having, for an RF embodiment, an embedded antenna 60A. Preferably, the lens/CCD system 20 includes a digital camera of adequate resolution (e.g., 1.45 mega pixels or greater), with appropriate support circuitry providing auto-focus and other typically found features. The image capture sub-system works in cooperation with other components of the hand-held system 5.

A microphone 25 can be provided for use with the presently preferred embodiment that includes a wireless transceiver. In one embodiment, the device 5 is water proof, or water resistant, and designed for use in humid or wet environments.

The device 5 may be battery powered, or powered by an external power supply. Preferably, the apparatus is sized so that it can be readily manipulated with one hand by the operator, in much the same manner that a digital camera or a wireless communications device can be manipulated by a user.

In accordance with a preferred embodiment of this invention the memory 15, or more preferably the non-volatile storage 18, includes one or more data sets representing digital watermark algorithms (DWAs) 18A that are preloaded into the device 5. Each DWA 18A is used as one input to the DWS 15A. Preferably, the DWS 15A communicates with the operating system of the device 5, enters data into the DWA 18A, receives output of the DWA 18A, and produces the data representing the digitally watermarked image. In some embodiments, the DWS 15A and the DWA 18A are integrated as one software unit. In some other embodiments, the DWS 15A is integrated into the operating system of the device 5.

Some type of location determining system (LDS) 70 is preferably provided within the device 5, such as one based on the Global Positioning System (GPS). In another embodiment, the LDS 70 is connected to the device 5 through a communication port, or other appropriate connection. In this case, the location of the LDS 70, the accompanying device 5, and the location of the subject, can be transferred to the remote data processor(s). It should be recognized that the LDS 70, when connected through a communication port, can be located remotely from the device 5, and therefore report a location that is not necessarily indicative of the location of the subject. The precision of location determinations is therefore based upon, among other things, the relation of the LDS 70 to the subject. Other factors that relate to the precision of the location determination include, but are not limited to, the accuracy of the LDS 70, and the relation of the device 5 to the subject.

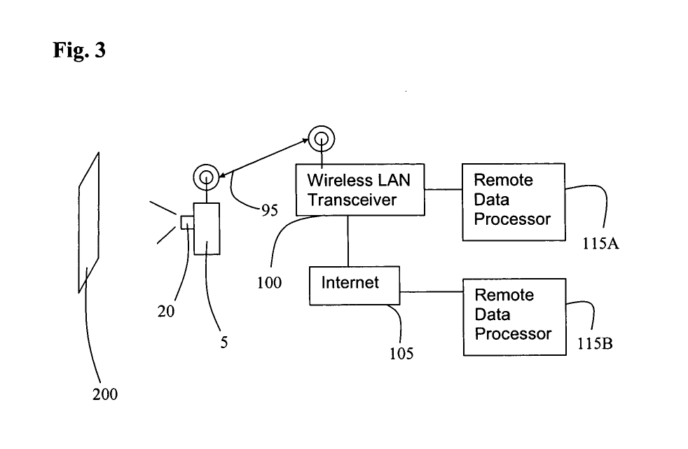

Referring now also to FIG. 3, the device 5 may execute a desired DWA 18A, either alone or in cooperation with one or more remote data processors 115. As shown in FIG. 3, a wireless link 95 may exist between device 5 and a wireless local area network (LAN) transceiver 100. The LAN transceiver 100 may be coupled directly to a first remote data processor 115A, and may possibly be coupled indirectly to a second remote data processor 115B through a wide area network (WAN), such as the Internet 105. Either one or both of the remote data processors 115 can be a source of DWAs 18A that are transferred into the device 5 using the wireless link 95 and associated components. Data representing one or more DWAs 18A may be inputted to the device 5 using the wireless link 95, or the data can be loaded using a wired connection, such as through a USB port, or by inserting a preprogrammed memory card or media. That is, in one embodiment the storage 18 may be removable from and installable within the device 5. Image data may be transferred in the same fashion as a DWA 18A.

The DWAs 18A can thus be updated as new and better digital watermarking algorithms are developed, or as user needs dictate. The DWAs 18A may be broadcast to a large number of devices 5 for updating them en masse while they are in use in the field. Likewise, digitally watermarked images, collected from a subject 200, may be transferred to a remote data processor 115.

In one embodiment, one or more of the remote data processors 115 could be associated with a law enforcement agency. For example, the device 5 may be used by a law enforcement agency for collecting of immigration data. In this example, the digitally watermark component may include information such as, but not limited to, time, date and location the image was collected. The image may include other information, such as information related to country of origin, or the identification of a persons' traveling companions. In this embodiment, the DWS 15A may collect input information from the lens/CCD system 20, the LDS 70, and a system clock 27. The DWS 15A may further incorporate information such as the name or identification number of the system operator. Using a selected DWA 18A, the DWS 15A generates digital watermark data that is then incorporated into the image collected by the lens/CCD system 20 from the subject 200 to create a digitally watermarked image.

In use, an operator of the device 5 holds the device 5 so as to obtain an image of the subject 200, and is enabled to readily change the location of the device 5 relative to the subject 200. This provides for rapidly making multiple images of a single subject 200.

The DWS 15A uses at least one of various data inputs or “input information” to create a digital watermark. The input information includes “evanescent information,” either alone or in combination with other types of information. As used herein, “evanescent information” pertains to extrinsic information which is at least partially related to the image, or the taking of the image, and at least one of: generally only known or available at the point of image creation; subject to frequent or rapid change; or, information which can be more reliably obtained at the point of image creation. Exemplary types of evanescent information may include, without limitation, information that is one of geographic, temporal, custodial, meteorological, financial, biometric, criminal, civil and travel related. Evanescent information may be derived from, or related to, the subject 200, and may be incorporated into a digital watermark automatically by the apparatus 5, or the system operator may be prompted for data input.

Examples of biometric information include, but are not limited to, data produced by various systems such as readers used for producing hand geometry data, facial recognition data, retinal scans, iris scans, fingerprints, voice samples, and other similar information. Biometric data will preferably be composed from individual features that are distinct for each individual. However, biometric data could include other quantities, such as, weight, hair color, height and others. Travel information could include, without limitation, citizenship status, identification of traveling companions, origin or destination, and other such information as is known to be of interest to authorities. Exemplary financial information could be derived from presently available assets of the subject of the image. Location information may include, without limitation, information about the device 5 in relation to the subject 200, geographic coordinates as may be obtained manually or by GPS 70, and/or elevational data. Temporal data may include any form of time or date. Meteorological information could include, without limitation, temperature or humidity. Custodial information could relate, without limitation, to present ownership, or bailment. Criminal information could include aspects of a criminal record, or pending charges. Civil information could include information such as identity of a temporary public official, such as during a disaster recovery. As one can understand from these examples, evanescent information encompasses a broad range of relevant information that can be important to users of a digital image.

As one example of incorporating evanescent information, a system operator may request that a subject 200 provide a fingerprint upon a scanner 38. The operator then captures an image of the subject 200. Aspects of the fingerprint are incorporated into the image to produce a digitally watermarked image. Although a fingerprint may be considered by some to be other than evanescent information (such as in the case of a known criminal having a finger print on record with authorities), such information is herein considered evanescent information. That is, it is considered that other means for production of a digitally watermarked image would not provide such a high degree of reliability as provided for herein. Consider that many criminals employ disguises to further their endeavors. Accordingly, subsequent incorporation of fingerprint data, such as at a remote location, may lead to erroneous data. Further, combinations of data (e.g., a fingerprint scan with the subjects' name, date of birth, etc, . . . ) may be used to enhance the data. Another example of evanescent information includes use of auditory input received through the microphone 25. One such example involves including aspects of a voice sample from a subject 200 in the digital watermark.

Evanescent information is not the only information that may be included in the digital watermark. For example, security codes, reference numbers, semantic information (such as date of birth, name, etc, . . . ) may be included in the input information used to create a digital watermark.

Once assembled, information may be encoded or encrypted by the DWA 18A in any manner that is considered suitable by the user. For example, the DWA 18A may include, but is not limited to, a discrete cosine transform embedding process, or some other pixel value modification or alteration process for generating the digital watermark.

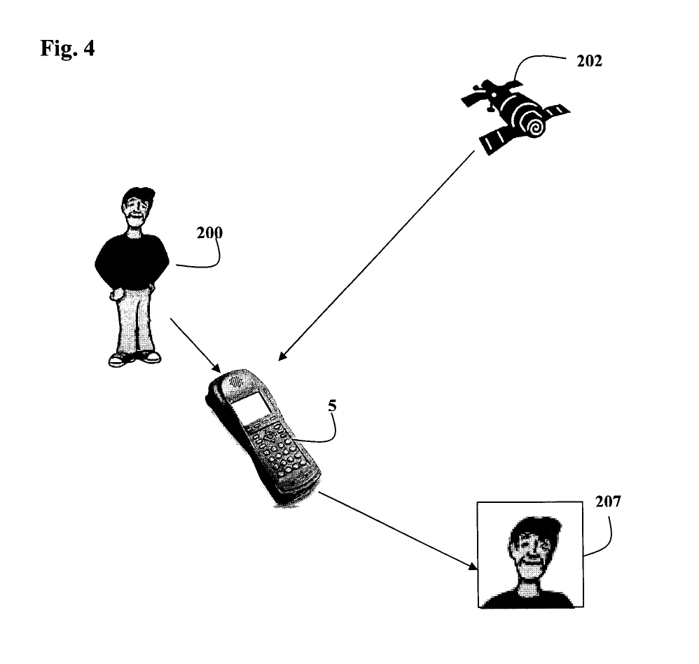

The device 5 could be connected to other processing equipment, such as a laptop computer (not shown). In one embodiment, the laptop computer assembles data in a database that includes multiple images having separate records of the evanescent information. The laptop assembles digitally watermarked images from the images and records of evanescent information. In another embodiment, a series of digitally watermarked images could be taken at a remote location for subsequent use. For example, digitally watermarked images could be collected during a recovery operation at a crash site, where information such as date, time and location are incorporated into images of pieces of wreckage. An example is shown in FIG. 4 of the technique where evanescent information is used. In FIG. 4, location information is included in a digitally watermarked image 207.

FIG. 4 depicts a subject 200. The device 5 is used to collect a digital image of the subject 200, and to combine input information with the digital image to create a digitally watermarked image 207. In this example, input information is received from a Location Determination System (LDS) 70, depicted as a satellite system 202. In another embodiment, the LDS 70 makes use of cellular communications capabilities, and location information provided through use of a cellular service and cellular location determining equipment. Further embodiments rely upon manual input of compass data, manual input of global positioning data, or other manual inputs. Another technique for determination of location may include relative location equipment such as a laptop, wherein the laptop contains preprogrammed information, such as a map, and on board sensors track movement relative to a starting location, thus providing a location relative to a starting point. It should be noted that input of location information may occur in any manner that is considered acceptable for the needs of the user.

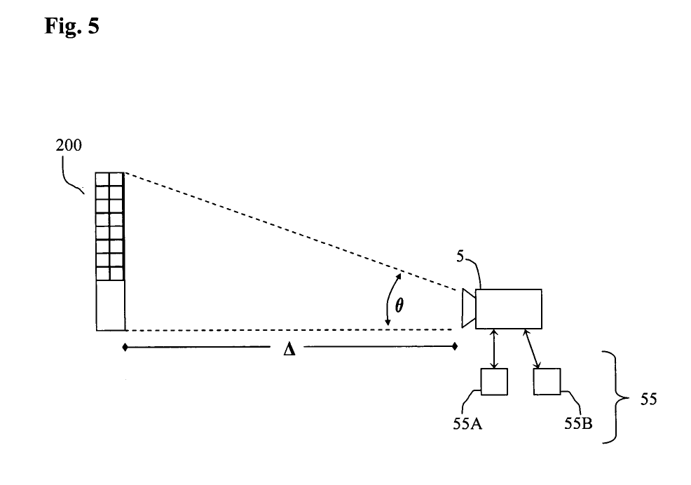

Additional examples of input information sources include, but are not limited to, input appliances, such as distance measuring equipment (DME). Use of DME 55 is depicted in FIG. 5. In FIG. 5, DME 55 is used to provide input data to the device 5. In this embodiment, an input appliance 55 provides data that is descriptive of the location of device 5 in relation to the subject 200. For example, the device 5 may communicate with an inclinometer 55A, and a laser or acoustic range finder 55B. The device 5 may control the DME 55 as needed to exchange information, and initiate measurements or sequences. The combination of the device 5 and the DME 55 may be used to generate information related to a subject 200. For example, in FIG. 5, the device 5, which is connected to appropriately configured DME 55, is directed to a subject 200 some distance away. In this case, where the subject 200 is a building, the device 5 is able to provide a determination of the height of the building 200. This determination is made through use of the DME 55 provided information, and appropriate software 15A. In this embodiment, the DME 55 provides information, such as but not limited to, the angle, shown here as theta, between grade level and a horizontal plane drawn through the inclinometer 55A, as the device 5 is pointed at the building 200. An example of additional information includes the distance from the subject 200 to the device 5, shown here as delta. In this embodiment, the software 15A calculates dimensions of the subject 200 using the exemplary input information. Aspects of height, width or other physical attributes may be determined in this manner, or in other ways, such as in the next embodiment.

In another embodiment, only the distance between the device 5 and the subject 200, shown in FIG. 5 as delta Δ, is needed as input information. In this embodiment, the DWS 15A combines delta Δ with known characteristics of the device 5, and image data to determine data related to the subject 200. For example, field-of-view information for the device 5 may have been previously characterized and retained as a data set, where the data set is stored in memory 15 or non-volatile storage 18. Alternatively, the field-of-view may be stored as an algorithm in memory 15 or non-volatile storage 18. Once delta Δ is ascertained, the device 5 is enabled to enter into dimensional analysis of image data taken from the subject 200.

Further examples of input information include azimuth and elevation measurement data related to the subject 200. In these examples, the azimuth and elevation data may be input manually by the user, or through automated means in a manner similar to the use of DME 55 as discussed. The coordinate system used for describing the azimuth and elevation may be a conventional system or user defined as appropriate. The azimuth may be determined relative to magnetic North, as obtained from a compass that is included within the device 5, manually entered compass data, or the azimuth may be determined by relative bearing to any suitable coordinates.

Note as well that the device 5 can operate in conjunction with other devices 5 in a networked environment. For example, the device 5 could be used with another device 5, both of which are connected to a laptop computer. In this configuration, a system operator could produce a stereographic digitally watermarked image 207, where the laptop could be used for combining the images collected by each device 5. In another embodiment, the use of a microphone 25 could facilitate note taking in field environments.

Data may be stored in any structure determined appropriate by the user. For example, a digitally watermarked image 207 may be produced and stored in memory 15, or in the non-volatile storage 18. Alternatively, a user may prefer to retain additional associated information. For example, a user may wish to retain a data set for each image that includes the digital data representing the original image, the input information, such as the date, time and location, output of the DWA 18A, and the digital watermarked image 207. Further embodiments include storage of system parameters, algorithm 18A identity and other data in each data set. The actual structure and content of the data retained is therefore flexible, and is limited by user need, and device 5 characteristics, such as available memory 15.

In other embodiments of data storage techniques, input data that is used for creation of a digitally watermarked image 207 is stored separately from the image, prior to digital watermarking of the image. For example, location information, information relating to the positioning of the device 5, and/or other inputs may be stored in conjunction with the image. Further embodiments include storage of system parameters, algorithm 18A identity and other user defined data in each data set. The data set may be later referred to by the device 5 to create a digitally watermarked image 207, alternatively, the data set, or portions thereof, may be transferred to a remote processor 115 for subsequent processing. The actual structure and content of the data retained is therefore flexible, and is limited by user need, and device 5 characteristics, such as available memory 15. In another embodiment, the image may be digitally watermarked with a reference number. The reference number may serve as an identifier to correlate with a data set that is stored separately and related to the digital image. In another embodiment, the image may not be digitally watermarked, and the data set is stored separately and linked to the digital image for subsequent use or reference.

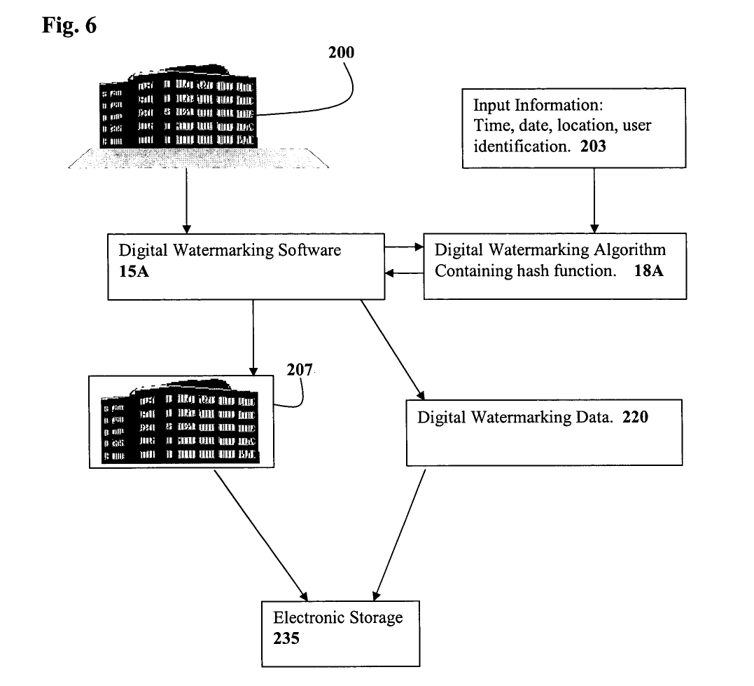

FIG. 6 provides a summary of the steps for operation of the device 5, where the device 5 is used for digital watermarking of an image. In FIG. 6, a subject 200 is shown as a building. The device 5 is used to collect an image of the building 200, and to obtain various input information 203 for inclusion in a digital watermark. In this case, the input information 203 includes time, date, location and user identification. The digital watermarking algorithm (DWA) 18A is called by the digital watermarking software 15A to produce digital watermark inputs to the image data of building 200. In this embodiment, the DWA 18A uses a digital signature hash function to produce digital watermarking data 220. The digital watermarking data 220 is included in the image of the subject by the digital watermarking software 15A, thereby producing a digitally watermarked image 207. The digitally watermarked image 207 is then stored in electronic storage 235 with the accompanying digital watermarking data 220 and/or input data 203 used to develop the digitally watermarked image 207. In this embodiment, the electronic storage 235 is at least one of the on board memory 15, the on board non-volatile storage 18, or storage systems at a remote location, which are accessed through communication ports and a remote processor 115.

The digital signature hash function may be used to provide a variety of advantages. For example, using a known function having a limited distribution, a user is provided with further security of the information in the digitally watermarked image 207. The security benefit may be enhanced through the additional input of a security code into the hash function. Other advantages include providing a technique for condensing quantities of information. Accordingly, as used herein, a “digital signature hash function” refers to any type of algorithm that provides for a condensing or encoding of the digital watermarking data 220.

Note that the device 5 is capable of providing continuous imaging of a subject 200. In this embodiment, the device 5 may be connected to a high volume storage media, such as a videotape device. The device 5 may be advantageously coupled with an LDS 70. Here, data from the LDS 70 may be continuously incorporated into the video produced by the device 5. Alternatively, data from the LDS 70 may be incorporated at intervals that meet user needs or device 5 limitations. Thus, the device 5 can provide a digitally watermarked video, wherein ongoing location information is incorporated into the video as a discreet record. In other embodiments, other data may be included in the video, either as a supplement or as a replacement to the data from the LDS 70. For example, date and time may be included. In another embodiment, the other data (e.g., date and time) is included only at the beginning of a video record. Alternatively, the other data is recorded in an ongoing basis, in order to preserve record of the other data during subsequent editing of the video.

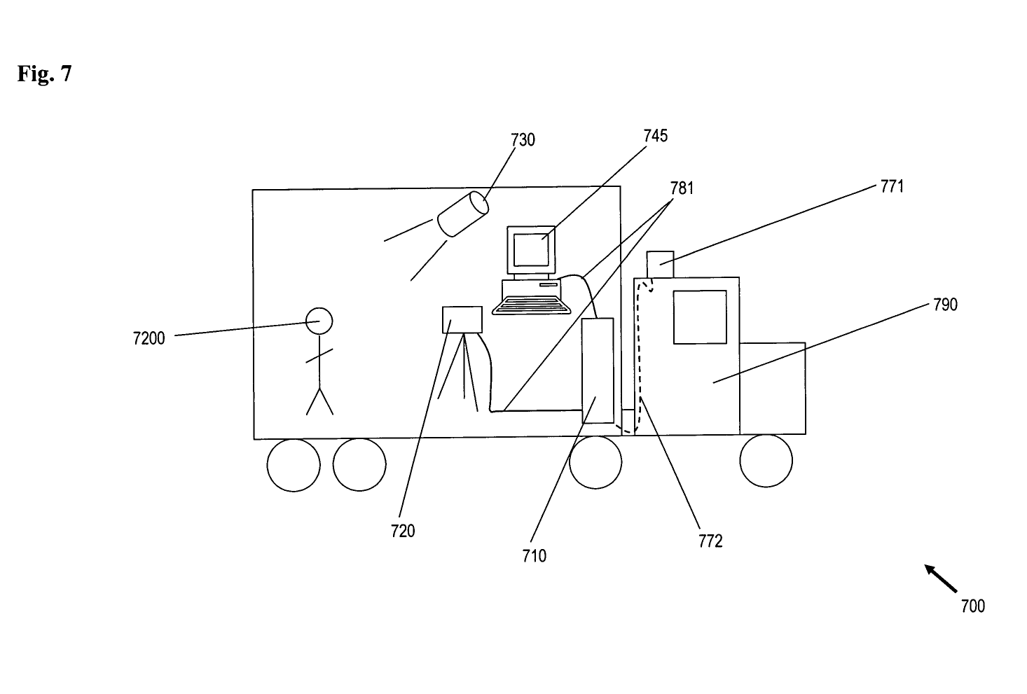

FIG. 7 illustrates a second embodiment of the device 700. In FIG. 7, various components of the device 700 are separately housed, and connected appropriately by connections 781, 772. In FIG. 7, the device 700 is mounted in mobile unit 790, depicted as a trailer truck 790. In this embodiment, a GPS antenna 771 is included for providing GPS signal information to a central processing unit (CPU) 710 by a GPS antenna connection cable 772. The CPU 710 is connected to a user interface 745 by a connection cable 781. The CPU 710 is also connected to a tripod mounted lens/CCD system 720 by a connection cable 781. A separate illumination system 730 is included. In this embodiment, the operator positions the subject 7200 in a standard relation to the illumination system 730. Accordingly, an interface between the illumination system 730 and the CPU 710 is not required.

A result is that discreet and rapid production of digitally watermarked images 207 are possible, with a field based device 5 that may be used in a variety of settings. This device 5, which is preferably hand-held, is capable of supporting a variety of information and communication protocols, which lend versatility to the device 5 and the applications for which it may be used. The image 207 produced contains evanescent information that is useful for authenticating a subject or disclosing extrinsic information associated with the subject 200 to an authorized user of the digital image 207.

It should be appreciated that while these teachings have been particularly shown and described with respect to preferred embodiments thereof, it will be understood by those skilled in the art that changes in form and details may be made therein without departing from the scope and spirit of the invention.

What is claimed is:

1. A digital watermarking system, comprising:
a mobile device comprising an image capture sub-system for generating digital data representing an image from one or more desired vantage points;
input information comprising at least one piece of evanescent information; and,
a data processor for processing the digital data, where the data processor derives digital watermarking data from a digital watermarking algorithm and input information and the processor incorporates the digital watermarking data into the digital data to produce a digitally watermarked image.

2. A system as in claim 1, further comprising a wireless link for transmitting from the device to a remote data processor at least one of the digital data, the input information and the digitally watermarked image.

3. A system as in claim 2, where the digital data is received through the wireless link from a data communications network for storage within the mobile device.

4. A system as in claim 3, where the data communications network comprises the Internet.

5. A system as in claim 2, where the wireless link comprises an interface to a remote data processor that is reachable through the Internet.

6. A system as in claim 5, where the data processor that processes the digital data comprises the remote data processor.

7. A system as in claim 1, wherein the evanescent information comprises at least one of location information, biometric information, meteorological information, temporal information, custodial information, financial information, criminal information, civil information, physical attribute information, and travel information.

8. A system as in claim 7, wherein the travel information comprises at least one of point of origin, destination, citizenship and identity of traveling companions.

9. A system as in claim 7, wherein the biometric information comprises at least one of hand geometry data, facial recognition data, retinal scan data, iris scan data, fingerprint data, and voice data.

10. A system as in claim 7, wherein the location information comprises at least one of geographic coordinates, a relative bearing, a relative distance and an elevation.

11. A system as in claim 1, wherein the mobile device comprises a device that is one of hand-held and vehicle mounted.

12. An imaging system, comprising:
a mobile imaging device for creating a digital image of a subject, the device comprising a location determination system and a processor for digital watermarking the digital image with at least location information received from the location determination system.

13. An imaging system as in claim 12, wherein the location information comprises at least one of longitude, latitude, elevation, relative bearing, and relative distance.

14. An imaging system as in claim 12, wherein the location determination system comprises at least one of a global positioning system (GPS) receiver, cellular location determining equipment, relative location equipment, a distance measuring equipment (DME) and an inclinometer.

15. An imaging system, comprising:
a mobile imaging device for creating a digital image of a subject, the device comprising a biometric data input mechanism and a processor for digital watermarking the digital image with at least biometric data received from the input mechanism.

16. An imaging system as in claim 15, wherein the biometric data comprises at least one of hand geometry data, facial recognition data, retinal scan data, iris scan data, fingerprint data, and voice data.

17. An imaging system as in claim 15, wherein the biometric data comprises at least one of height, weight and hair color.

18. A method for digitally watermarking a digital image, the method comprising:
generating digital data representing an image from one or more desired vantage points using a mobile device comprising a image capture sub-system;
obtaining evanescent information as at least one input information for a digital watermarking algorithm;
inputting the input information into the digital watermarking algorithm to produce digital watermarking data; and,
processing the digital data to include the digital watermarking data to produce a digitally watermarked image.

19. A method as in claim 18, wherein the processing is completed by a remote data processor.

20. A method as in claim 18, wherein the obtaining comprises at least one of operating a biometric data input mechanism, operating a location determination system, operating a range finder, operating an inclinometer, querying a system clock, querying financial records, and interrogating a subject of the image.

21. A method as in claim 18, wherein processing the digital data comprises using a discrete cosine transform process.

22. A method as in claim 18, wherein processing the digital data comprises using a pixel modification process.

23. A method as in claim 18, wherein processing the digital data comprises using a digital signature hash function.

24. A method for digitally watermarking a series of digital images, the method comprising:
using a mobile device comprising an image capture sub-system, producing a series of digital data sets, each set representing a digital image;
obtaining evanescent information pertaining to the series as at least one piece of input information for a digital watermarking algorithm;
inputting the input information into the digital watermarking algorithm to produce digital watermarking data; and,
processing at least one set of digital data to include the digital watermarking data to produce a digitally watermarked image.
